(19) United States
(12) Patent Application Publication
(10) Pub. No.: US 2017/0324914 A1
(43) Pub. Date: Nov. 9, 2017

(54) CORRECTING DISTURBANCE IN A PIXEL SIGNAL INTRODUCED BY SIGNAL FILTERING IN A DIGITAL CAMERA

(71) Applicant: GoPro, Inc., San Mateo, CA (US)

(72) Inventor: Scott Patrick Campbell, Belmont, CA (US)

(21) Appl. No.: 15/150,281

(22) Filed: May 9, 2016

(51) Int. Cl. H04N 5/359

(52) U.S. Cl. CPC H04N 5/359

(57) ABSTRACT

A camera is configured with a disturbance correction engine that identifies and corrects disturbance introduced in image data when a filter is applied to the image data. The disturbance may take the form of overshoot noise, crosstalk noise, and/or low pass band energy. The disturbance correction engine determines an amount of energy deficit in the pass band and compensates for the deficit using the increase in energy in the side band. In operation, the disturbance correction engine processes the filtered image data in the frequency domain to adjust the amplitudes of the image coefficients. The adjusted image coefficients compensate for the deficit of energy in the pass band and also correct the disturbance caused by the overshoot and the crosstalk.

### BACKGROUND

### 1. FIELD OF ART

The disclosure generally relates to the field of digital image and video capture and processing, and more particularly to correcting post-filtering disturbance in a pixel signal.

### 2. DESCRIPTION OF THE RELATED ART

Digital cameras capture images using an electronic image sensor. The camera may apply filters to the captured image to correct defects or improve the overall quality of the captured image. Such filters include smoothing filters, edge sharpening filters, etc. Oftentimes, the filtering process introduces disturbance (or “noise”) into the filtered image. The noise can take the form of pixel crosstalk, low pass band energy, and/or pixel overshoot. While filtering is important to improve the quality of the captured image, the disturbance introduced by the filtering process may ultimately lead to an undesirable amount of degradation in the quality of the final image.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a block diagram illustrating an example camera architecture, according to one embodiment.

FIG. 2 is a conceptual diagram illustrating an uncorrected and a corrected filtered pixel signal, according to one embodiment.

FIG. 3 is a block diagram of the system memory, filter engine, and disturbance correction engine of FIG. 1, according to one embodiment.

FIG. 4 is a flow diagram illustrating a process for correcting the post-filtering disturbance in a pixel signal, according to one embodiment.

FIG. 5A illustrates a front perspective view of an example camera, according to one embodiment.

FIG. 5B illustrates a rear perspective view of an example camera, according to one embodiment

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable, similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### EXAMPLE CAMERA ARCHITECTURE

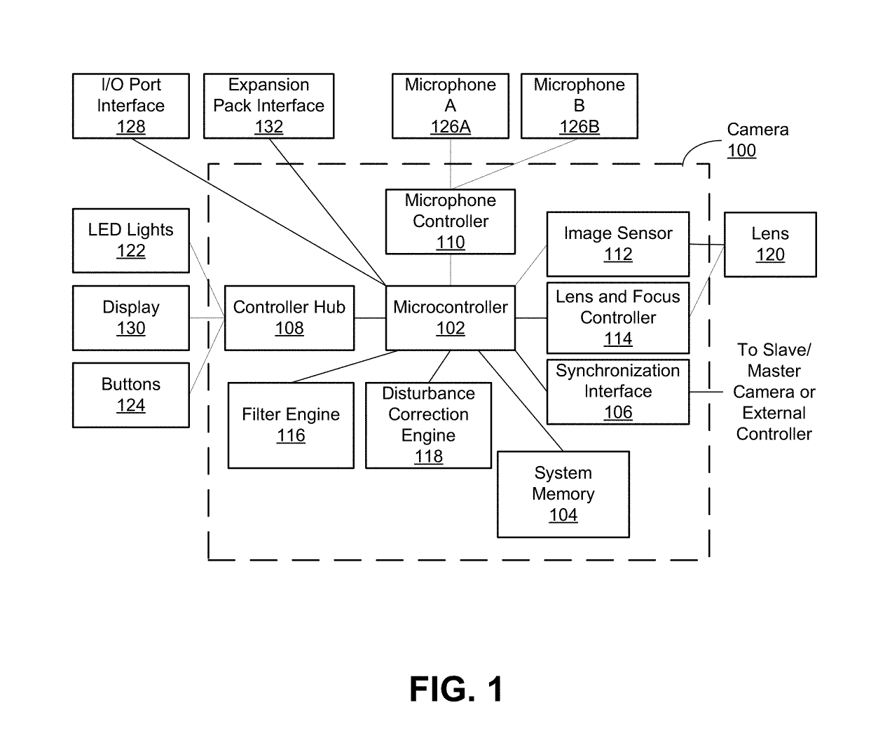

(FIG.) 1 is a block diagram illustrating an example camera architecture, according to one embodiment. The camera 100 of the embodiment of FIG. 1 includes one or more microcontrollers 102, a system memory 104, a synchronization interface 106, a controller hub 108, one or more microphone controllers 110, an image sensor 112, a lens and focus controller 114, one or more lenses 120, one or more LED lights 122, one or more buttons 124, one or more microphones 126, an I/O port interface 128, a display 130, and an expansion pack interface 132. Various embodiments may have additional, omitted, or alternative modules configured to perform at least some of the described functionality. It should be noted that in other embodiments, the modules described herein can be implemented in hardware, firmware, or a combination of hardware, firmware, and software. In addition, in some embodiments, the illustrated functionality is distributed across one or more cameras or one or more computing devices.

The camera 100 includes one or more microcontrollers 102 (such as a processor) that control the operation and functionality of the camera 100. For instance, the microcontrollers 102 can execute computer instructions stored on the system memory 104 to perform the functionality described herein. It should be noted that although the functionality herein is described as being performed by the camera 100, in practice, the camera 100 may capture image data, provide the image data to an external system (such as a computer, a mobile phone, or another camera), and the external system may filter the captured image data and correct any resulting disturbance introduced into the filtered image data.

The system memory 104 is configured to store executable computer instructions that, when executed by the microcontroller 102, perform the camera functionalities described herein. The system memory 104 also stores images captured using the lens 120 and image sensor 112. The system memory 104 can include volatile memory (e.g., random access memory (RAM)), non-volatile memory (e.g., a flash memory), or a combination thereof

The lens and focus controller 114 is configured to control the operation, configuration, and focus of the camera lens 120, for example, based on user input or based on analysis of captured image data. The image sensor 112 is a device capable of electronically capturing light incident on the image sensor 112 and converting the captured light to image data. The image sensor 112 can be a CMOS sensor, a CCD sensor, or any other suitable type of image sensor, and can include corresponding transistors, photodiodes, amplifiers, analog-to-digital converters, and power supplies.

The synchronization interface 106 is configured to communicatively couple the camera 100 with external devices, such as a remote control, another camera (such as a slave camera or master camera), a computer, or a smartphone. The synchronization interface 106 may transfer information through a network, which allows coupled devices, including the camera 100, to exchange data other over local-area or wide-area networks. The network may contain a combination of wired or wireless technology and make use of various connection standards and protocols, such as WiFi, IEEE 1394, Ethernet, 802.11, 4G, or Bluetooth.

The controller hub 108 transmits and receives information from user I/0 components. In one embodiment, the controller hub 108 interfaces with the LED lights 122, the display 130, and the buttons 124. However, the controller hub 108 can interface with any conventional user I/O component or components. For example, the controller hub 108 may send information to other user I/O components, such as a speaker.

The microphone controller 110 is configured to control the operation of the microphones 126. The microphone controller 110 receives and captures audio signals from one or more microphones, such as microphone 126A and microphone 126B. Although the embodiment of FIG. 1 illustrates two microphones, in practice, the camera can include any number of microphones. In some embodiments, the microphone controller 110 selects which microphones from which audio data is captured. For instance, for a camera 100 with multiple microphone pairs, the microphone controller 110 selects one microphone of the pair to capture audio data.

Additional components connected to the microcontroller 102 include an I/O port interface 128 and an expansion pack interface 132. The I/O port interface 128 may facilitate the camera 100 in receiving or transmitting video or audio information through an I/O port. Examples of I/O ports or interfaces include USB ports, HDMI ports, Ethernet ports, audio ports, and the like. Furthermore, embodiments of the I/O port interface 128 may include wireless ports that can accommodate wireless connections. Examples of wireless ports include Bluetooth, Wireless USB, Near Field Communication (NFC), and the like. The expansion pack interface 132 is configured to interface with camera add-ons and removable expansion packs, such as an extra battery module, a wireless module, and the like.

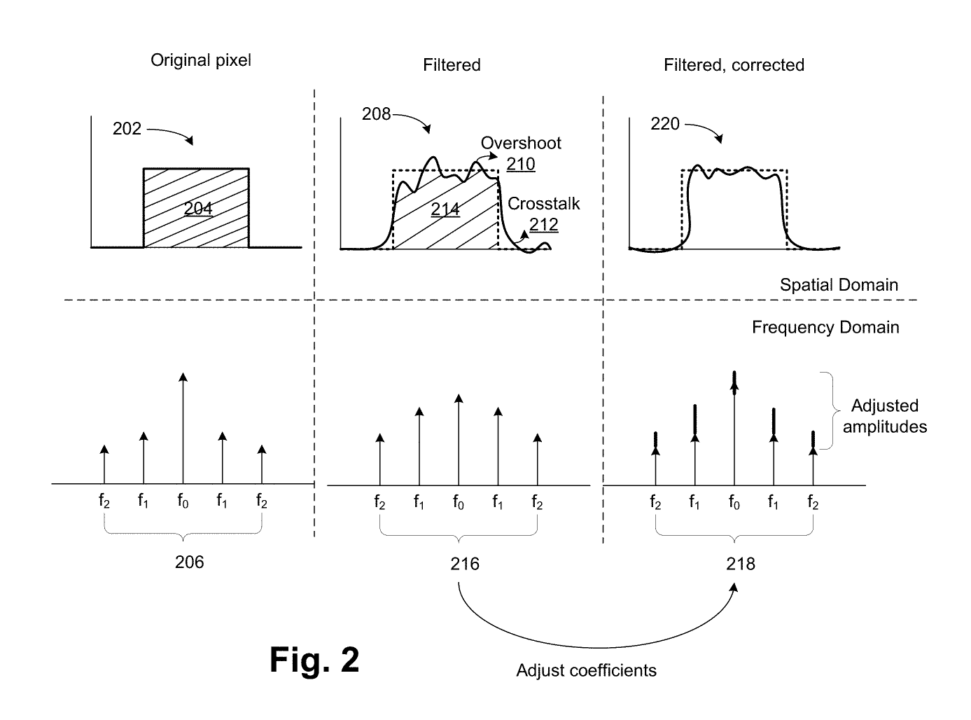

The filter engine 116 is configured to apply one or more filters to the image data captured by the image sensor 112. In some embodiments, filtering an image introduces disturbance into the image data. The disturbance correction engine 118 is configured to identify the disturbance introduced into the filtered image data and to correct the disturbance. The detailed operation of the filter engine 116 and the disturbance correction engine 118 is further explained in conjunction with the description of FIGS. 2-4 below. In the illustrated embodiment of FIG. 1, the filter engine 116 and the disturbance correction engine 118 are located within the camera 100. In some embodiments, the filter engine 116 and/or the disturbance correction engine 118 are located external to the camera 100, for instance, in a post-processing computer system, in a cloud server, and the like.

### Correcting Disturbance in Filtered Image Data

FIG. 2 is a conceptual diagram illustrating image data of a pixel in the spatial and the frequency domains at different points in the filtering and subsequent correction process, according to one embodiment.

An image, such as a still image or a video frame captured by the image sensor 112, includes image data in the spatial domain. The image data may be captured over one or more channels. A channel indicates the intensity of light captured over a broad or narrow spectrum of light wavelengths or frequencies. For example, the image data may include one channel (e.g., grayscale), or three channels (e.g., RGB (red, green, blue)). In one embodiment, the image data includes analog signals corresponding to individual image pixels.

Signal 202 is an analog signal corresponding to a pixel of an image captured by the image sensor 112. The area 204 of the signal 202 is representative of a quantity of energy present in the pass band of the signal. The signal 202 may be converted from the spatial domain to the frequency domain. For example, the conversion is based on a linear transformation of the signal 202, such as the application of a discrete Fourier transform or a discrete cosine transform. The image coefficients 206 correspond to the signal 202 in the frequency domain and indicate the relative weighting of different spatial frequencies in a linear decomposition of the image data into transform-specific basis functions (e.g., cosines, sines, complex exponentials). It should be noted that, although the description here refers to transforming a signal from the spatial domain to the frequency domain when correcting signal disturbance, the correction techniques described herein apply equally to other domains.

As discussed above, the filter engine 116 may apply one or more filters to the signal 202. Signal 208 is an analog signal resulting from the filter engine 116 applying at least one filter to the signal 202. As illustrated, filtering the signal 202 introduces disturbance to the resulting signal 208. Specifically, the signal 208 has an overshoot 210, crosstalk 212, and, as indicated by the area 214, lower energy in the pass band relative to the signal 202.

The image coefficients 216 correspond to the signal 208 in the frequency domain. Because of the disturbance introduced to the signal 208 during the filtering process, the image coefficients 216 have amplitudes that are different from the amplitudes of the image coefficients 206. Specifically, the amplitude of the first order coefficient f₀ in the image coefficients 216 is lower than the amplitude of the first order coefficient f₀ in the image coefficients 206. This difference in amplitudes in the first order coefficients is caused by the lower energy in the pass band of signal 208 relative to the pass band of signal 202. The amplitude of the second order coefficient f₁ in the image coefficients 216 is higher than the amplitude of the second order coefficient f₁ in the image coefficients 206. This difference in amplitudes in the second order coefficients is caused by the overshoot 210 and/or the crosstalk 212 of the signal 208. Similarly, the amplitude of the third order coefficient f₂ in the image coefficients 216 is higher than the amplitude of the third order coefficient f₂ in the image coefficients 206. This difference in amplitudes in the third order coefficients is also caused by the overshoot 210 and/or the crosstalk 212 of the signal 208. It should be noted that, while only the first, second, and third order coefficients are discussed here, there are any number of frequency domain coefficients, and the principles described herein apply equally to those coefficients.

As discussed above, the disturbance correction engine 118 identifies the disturbance introduced in the signal 208, such as the overshoot 210, crosstalk 212, and low pass band energy, and corrects the identified disturbance. Specifically, the disturbance correction engine 118 determines an amount of energy deficit in the pass band and compensates for the deficit using the increase in energy in the side band, which causes the overshoot 210 and the crosstalk 212. In operation, the disturbance correction engine 118 adjusts the amplitudes of the image coefficients 216 to generate new image coefficients 218 that compensate for the deficit of energy in the pass band and also correct the disturbance caused by the overshoot 210 and the crosstalk 212. The resulting coefficients 218 correspond to the signal 220 in the spatial domain. In some embodiments, the signal 220 matches the signal 202 perfectly. In other embodiments, the signal 220 is not a perfect match with signal 202, but is a better match to the signal 202 relative to the signal 208 (e.g., the disturbances of signal 220 are reduced relative to signal 214).

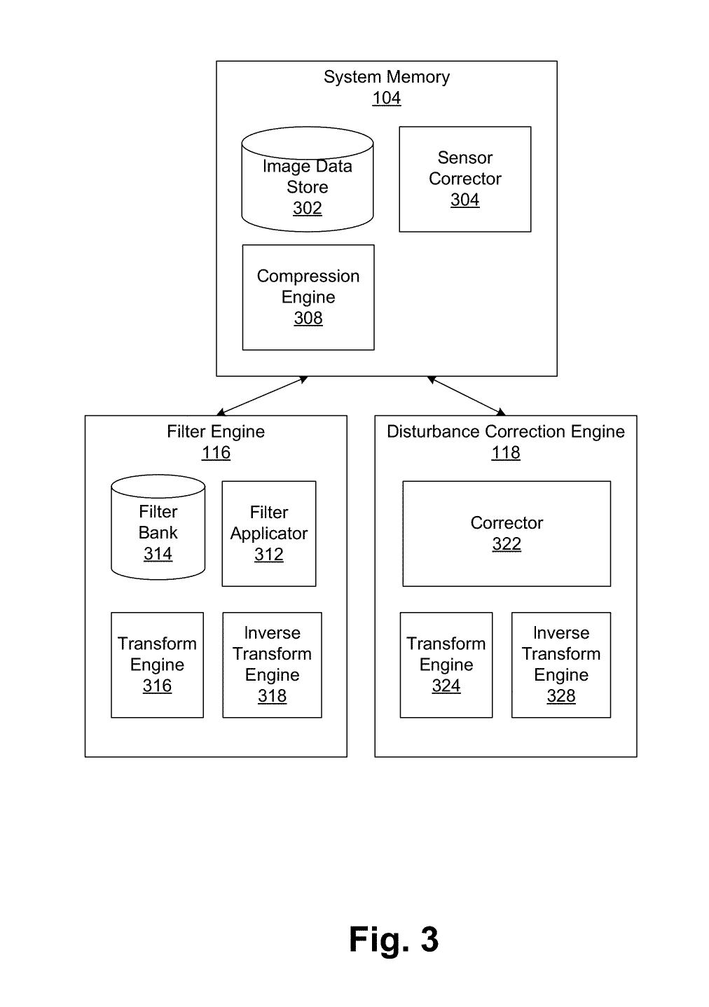

FIG. 3 is a block diagram of the system memory 104, filter engine 116, and disturbance correction engine 118 of FIG. 1, according to one embodiment. The system memory 104 includes an image data store 302, a sensor corrector 304, and a compression engine 308.

The image data store 302 is configured to store images captured by the image sensor 112. In some embodiments, the image data store 302 stores raw image data from the image sensor 312, filtered image data from the filter engine 116, corrected image data from the disturbance correction engine 118, and compressed image data from the compression engine 308. The image data store 302 may store image data received from another camera through the synchronization interface 106, or image data stored on removable memory accessed through the I/O port interface 128 or expansion pack interface 132.

The sensor corrector 304 accesses raw image data captured by the image sensor 112, modifies the raw image data based on properties of the image sensor, and outputs corrected image data. For example, the sensor corrector 304 performs black level correction, corrects defective pixels (e.g., dead pixels that produce no image data, hot pixels that produce saturated image data), performs auto white balance operations, or corrects for lens shading defects. The sensor corrections may correct for distortion due to inherent properties of the camera (e.g., properties of the lens 120), settings of the camera (e.g., zoom level), or a combination thereof. For example, the sensor corrector 304 corrects lens shading defects of raw images using a lens shading correction table, and corrects tone in raw images using a tone curve table. Example settings of the camera that can introduce distortion include exposure and focus statistics automatically selected by the lens and/or the focus controller 114 for capturing an image.

The compression engine 308 applies one or more compression processes to compress image data. The compression engine 308 can compress the modified image data (the image data in the signal domain) or the modified image coefficients (the image data in the frequency domain). For example, the compression engine 308 can apply a compression algorithm based on the JPEG, JPEG2000, VC-5, or H.264 compression standards. In one embodiment, the compression engine 308 determines coefficients in a frequency domain, quantizes the coefficients (e.g., dividing by a constant or applying a quantization matrix and rounding the result), and then encodes the resulting non-zero coefficients (e.g., using differential pulse code modulation or entropy coding). The compression engine 308 may perform additional compression-related operations, such as dividing the image data into macroblocks to perform block-level compression for more efficient processing.

The filter engine 116 includes a transform engine 316, a filter applicator 312, a filter bank 314, and an inverse transform engine 318. The transform engine 316 accesses image data associated with a given image that is stored in the image data store 302, converts the image data from a spatial domain to a frequency domain, and outputs image coefficients representative of the image in the frequency domain. Specifically, each pixel in the image is associated with a set of image coefficients in the frequency domain. In one embodiment, the transform engine 316 applies a linear transform to the image data to produce the image coefficients. For example, the linear transform is the discrete Fourier transform, the fast Fourier transform, a discrete cosine transform, a fast cosine transform, a discrete wavelet transform, or a fast wavelet transform.

The filter bank 314 stores a set of filters that may be applied to the image coefficients generated by the transform engine 316. Each filter, when applied, modifies the image coefficients to achieve a particular result associated with the filter. Examples of filters that may be applied include low pass filters, e.g., filters for smoothing, or high pass filters, e.g., filters for edge enhancement. In one embodiment, the filter bank 214 stores, for each filter, a set of coefficient adjustments that specify how to adjust the amplitude of each image coefficient in the image data to achieve the result associated with the filter. For example, a given filter may specify that a first order image coefficient associated with a pixel should be adjusted by a particular percentage X, a second order image coefficient should be adjusted by a particular percentage Y, and a third order image coefficient should be adjusted by a particular percentage Z.

The filter applicator 312 selects one or more filters in the filter bank 314 to be applied to image coefficients generated by the transform engine 316 based on properties of the camera (e.g., properties of the lens 120 and available processing power), settings of the camera (e.g., zoom level), properties of the image itself (e.g., darkness or contrast of the image), or a combination thereof. The filter applicator 312 applies the selected filters to the image coefficients to produce adjusted image coefficients. In operation, for each pixel of an image associated with the image data, the filter applicator 312 adjusts the image coefficients associated with the pixel based on the selected filters. In the embodiment where the filter bank 314 stores a set of coefficient adjustments, the filter applicator 312 adjusts each image coefficient of the pixel according to the corresponding coefficient adjustment stored in the filter bank 314. In one embodiment, the filters may be applied in the spatial domain and the filtered image data is converted from the spatial domain to the frequency domain after the filter is applied.

The inverse transform engine 318 accesses adjusted image coefficients generated by the filter applicator 312 for each pixel of the image, converts the adjusted image coefficients from the frequency domain to the spatial domain, and outputs filtered image data. The filtered image data may be stored in the image data store 302 and/or transmitted to the disturbance correction engine 118 for further processing. In some embodiments, the inverse transform engine 318 applies an inverse of the transform used by the transform engine 316 (e.g., the inverse discrete Fourier transform, the inverse discrete Fourier transform, the inverse wavelet transform), though in other embodiments, the inverse transform engine 318 applies one or more different transforms to generate filtered image data.

The disturbance correction engine 118 includes a corrector 322, a transform engine 324, and an inverse transform engine 328. The transform engine 324 operates in the same manner as the transform engine 316. Specifically, the transform engine 324 accesses image data associated with a given image that is stored in the image data store 302 or received from the filter engine 116, converts the image data from a spatial domain to a frequency domain, and outputs image coefficients representative of the image in the frequency domain.

The corrector 322 analyzes filtered image data stored in the image data store 302 or received from the filter engine 116 to determine whether the filtered image data associated with a given pixel includes a disturbance that can be corrected. If the corrector determines that the filtered image data includes a disturbance, then the corrector 322 corrects the disturbance according to one or more correction functions.

In operation, the corrector 322 analyzes the image data associated with a pixel to determine a quantity of energy present in the pass band of the signal represented in the spatial domain and associated with the pixel. This quantity of energy in the pass band is referred to herein as E_{IB}. Using the filtered signal 208 in FIG. 2 as an example, E_{IB} is quantity of energy in the area 214. The corrector 322 also determines the quantity of energy present in the overshoot of the signal associated with the pixel. This quantity of energy in the overshoot is referred to herein as E_{O}. Again, using the filtered signal 208 in FIG. 2 as an example, E_{O} is the quantity of energy in the overshoot 210. The corrector 322 additionally determines the quantity of energy present in the crosstalk of the signal associated with the pixel. This quantity of energy in the crosstalk is referred to herein as E_{C}. Using the filtered signal 208 in FIG. 2 as an example, E_{C} is the quantity of energy in the crosstalk 212.

In one embodiment, the corrector 322 determines E_{IB}, E_{O}, and E_{C} based on the types of filters applied by the filter engine 116 to the original image data associated with the pixel. In such an embodiment, the corrector 322 may receive, along with the filtered image data, information related to the filters that were applied from the filter engine 116 or may independently determine such information based on the filtered image data. In an alternative embodiment, the corrector 322 determines E_{IB}, E_{O}, and E_{C} by measuring the energies in the pass band, overshoot, and crosstalk of the signal associated with the pixel. The corrector 322 may determine E_{IB}, E_{O}, and E_{C} based on average excess energies determined for past filtered pixel signals. Alternatively, the corrector 322 may determine E_{IB}, E_{O}, and E_{C} based on excess energies measured for test pixel signals.

The corrector 322 corrects the disturbance in the filtered image data based on the determined E_{IB}, E_{O}, and E_{C}. In correcting the filtered image data, the corrector 322 adjusts the energies in the filtered image data such that the filtered image signal associated with the pixel matches or is a close approximation of the original signal associated with the pixel. The corrector 322 corrects the filtered image data in the frequency domain and, therefore, prior to adjusting, requests the transform engine 324 to transform the filtered image data from the spatial domain to the frequency domain to generate filtered image coefficients. In one embodiment, the disturbance correction engine 118 receives filtered image coefficients from the filter engine 116 or the image data store 302, instead of, or in addition to, filtered image data in the spatial domain. In such an embodiment, the transform engine 324 does not perform transformation operations as the filtered image coefficients in the frequency domain are already available for the corrector 322.

The corrector 322 includes correction functions that, when applied to the filtered image coefficients, adjust the amplitudes of the filtered image coefficients based on the determined E_{IB}, E_{O}, and E_{C}. The adjusted amplitudes correct for the disturbance introduced during the filtering process. The corrector 322 includes a different function for adjusting the amplitudes of the first, second, and third order filtered image coefficients. For the first order filtered image coefficient, the corresponding correction function adjusts for the lower energy in the pass band of the filtered image data associated with the pixel relative to the original pixel. An example of such a correction function is:

$${A}_{{f}_{0 c}} = {f}_{0 uc} [ \frac{1}{{E}_{IB}} - 1 ]$$

where A_{foc}is the amount by which the amplitude of first order filtered image coefficient is to be adjusted, f_{0uc}is the first order image filtered coefficient, and E_{IB} is the quantity of energy present in the pass band of the filtered image data.

For the second order image coefficients, the corresponding correction function adjusts for the overshoot and crosstalk disturbances. An example of such a correction function is:

$${A}_{{f}_{\pm 1 c}} = {f}_{\pm 1 uc} [ 1 - \frac{( {E}_{O} + {E}_{C} )}{2} ]$$

where A_{f+1c} is the amount by which the amplitude of the second order filtered image coefficient is to be adjusted, f_{+1uc} is the second order filtered image coefficient, E_{O}is the quantity of energy present in overshoot of the filtered image data, and E_{C} is the quantity of energy present in crosstalk of the filtered image data.

An alternative correction function for adjusting the second order image coefficients to correct the overshoot and crosstalk disturbances is:

$${A}_{{f}_{\pm 1 c}} = {f}_{\pm 1 uc} [ \frac{{E}_{IB}}{2} ]$$

where A_{f+1c}is the amount by which the amplitude of the second order filtered image coefficient is to be adjusted, f_{1uc} is the second order filtered image coefficient, and E_{IB} is the quantity of energy present in the pass band of the filtered image data.

For the third order image coefficients, the corresponding correction function also adjusts for the overshoot and crosstalk disturbances. An example of such a correction function is:

$${A}_{{f}_{\pm 2 c}} = {f}_{\pm 2 uc} [ \frac{1}{{E}_{IB}} \cdot \frac{1}{2} ]$$

where A_{f+2c} is the amount by which the amplitude of the third order filtered image coefficient is to be adjusted, f_{+1uc} is the third order filtered image coefficient, and E_{IB} is the quantity of energy present in the pass band of the filtered image data.

The corrector 322 applies the amplitude adjustments A_{foc}, A_{f+1c}, A_{f+2c}to f_{0uc}, f_{+1uc}, and f_{+2uc}, respectively, to generate corrected image coefficients f_{0c}, f_{+1c}, and f_{+2c}. The corrected image coefficients adjust for the pass band, crosstalk, and overshoot disturbances introduced by the filter engine 116. Adjusting the amplitudes in such a manner effectively pulls energy from the crosstalk and the overshoot into the pass band, thus compensating for the lower pass band energy in the filtered image data while reducing the disturbance caused by the crosstalk and the overshoot.

The corrector 322 transmits the corrected image coefficients to the inverse transform engine 328 to transform the corrected image coefficients into corrected image data in the spatial domain. The corrected image data may be stored in the image data store 302 and/or transmitted to the compression engine 308 or any other component of the camera 100 for further processing. In some embodiments, the inverse transform engine 328 applies an inverse of the transform used by the transform engine 324 (e.g., the inverse discrete Fourier transform, the inverse discrete Fourier transform, the inverse wavelet transform), though in other embodiments, the inverse transform engine 328 applies one or more different transforms to generate filtered image data.

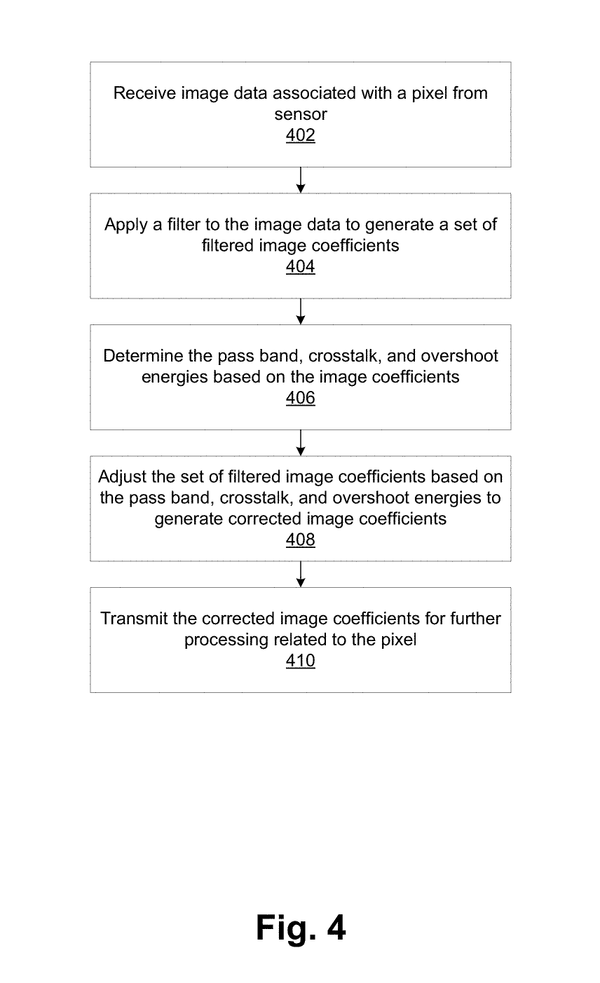

FIG. 4 is a flow diagram illustrating a process for correcting the post-filtering disturbance in a pixel signal, according to one embodiment.

The filter engine 116 receives 402 image data associated with a pixel from the image sensor 112. The image data received by the filter engine 116 is in the spatial domain. The filter engine 116 applies 404 at least one filter to the image data to generate a set of filtered image coefficients. In operation, the filter engine 116 selects the filter(s) to be applied to the image data based on certain criteria, such as the scene being captured and settings of the image sensor and/or the lens. The filter engine 116 converts the image data from the spatial domain to the frequency domain and then applies the selected filters to the image coefficients to generate the set of filtered image coefficients. Each filtered image coefficient is associated with a given order, such as a first, second or third order filtered image coefficient.

The filtering process often introduces disturbance into the filtered image coefficients, such that, if the filtered image coefficients are transformed to the spatial domain, the resulting signal has lower pass band energy relative to the original image data and also has side band disturbance caused by overshoot and crosstalk. The disturbance correction engine 118 processes the filtered image coefficients to determine 406 the quantity of energy in the pass band, the crosstalk, and overshoot portions of the resulting signal. These quantities are respectively referred to herein as E_{IB}, E_{O}, and E_{C}.

The disturbance correction engine 118 adjusts 408 the set of filtered image coefficients based on the energies determined in 406, i.e., E_{IB}, E_{O}, and E_{C}. Specifically, the corrector 322 includes correction functions that, when applied to the filtered image coefficients, adjust the amplitudes of the filtered image coefficients based on the determined E_{IB}, E_{O}, and E_{C}. The adjusted amplitudes correct for the disturbance introduced during the filtering process. The adjusted set of filtered image coefficients are referred to herein as the corrected image coefficients.

The disturbance correction engine 118 transmits 410 the corrected image coefficients for further processing related to the pixel. Any further processing, such as compression and storage, related to the pixel and/or the image in which the pixel is present, may use the corrected image coefficients to reduce amount of visible disturbance when the pixel and/or the image is stored or displayed.

### EXAMPLE CAMERA SYSTEM CONFIGURATION

A camera system includes a camera, such as camera 100, and a camera housing structured to at least partially enclose the camera. The camera includes a camera body having a camera lens structured on a front surface of the camera body, various indicators on the front of the surface of the camera body (such as LEDs, displays, and the like), various input mechanisms (such as buttons, switches, and touch-screen mechanisms), and electronics (e.g., imaging electronics, power electronics, etc.) internal to the camera body for capturing images via the camera lens and/or performing other functions. The camera housing includes a lens window structured on the front surface of the camera housing and configured to substantially align with the camera lens, and one or more indicator windows structured on the front surface of the camera housing and configured to substantially align with the camera indicators.

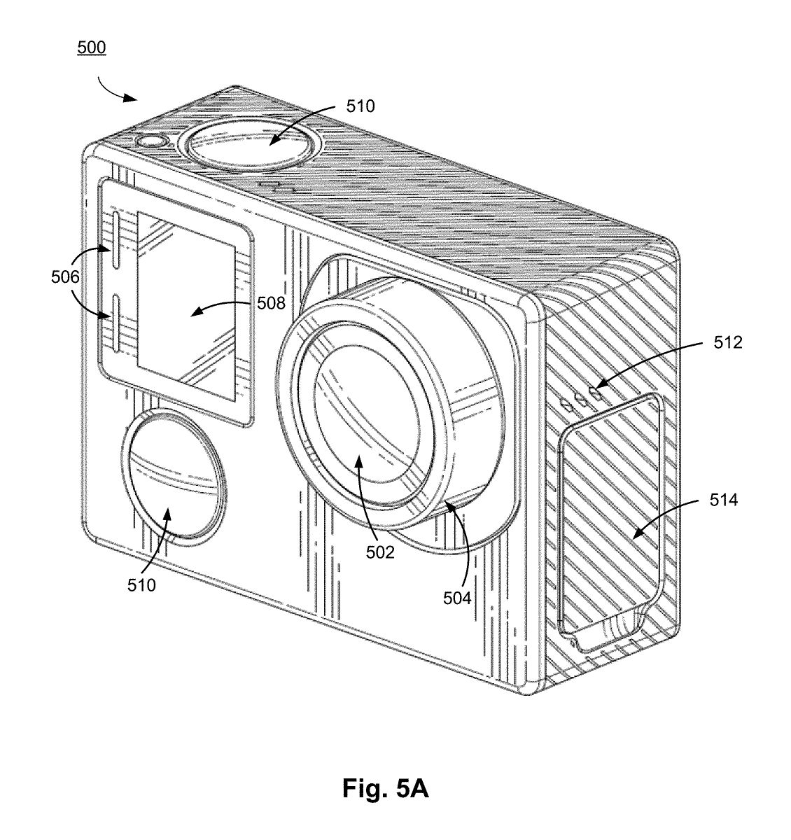

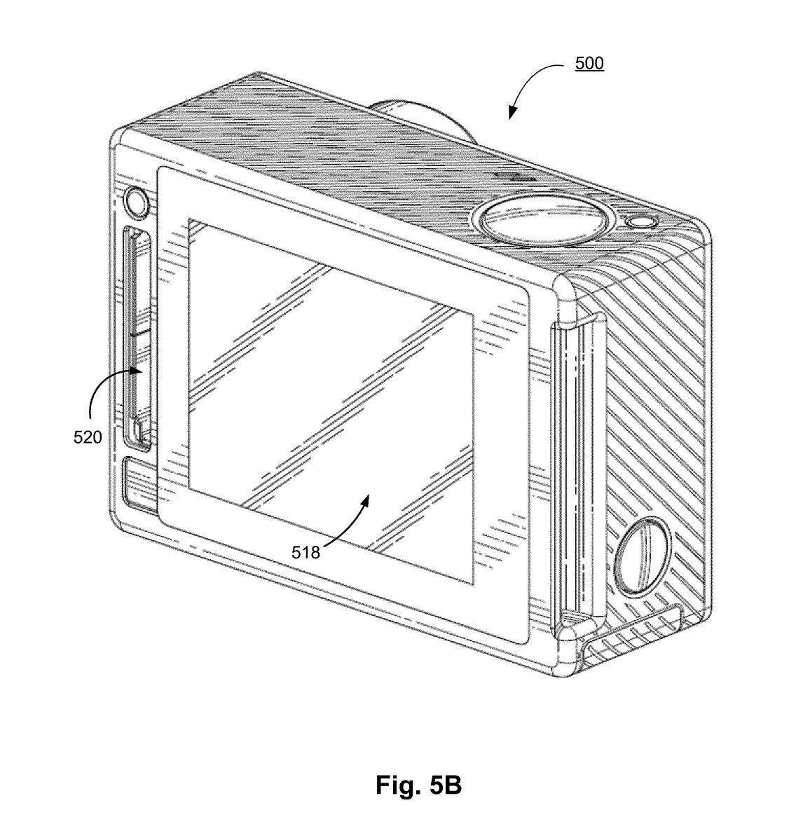

FIG. 5A illustrates a front perspective view of an example camera 500, according to one embodiment. The camera 500 is configured to capture images and video, and to store captured images and video for subsequent display or playback. The camera 500 is adapted to fit within a camera housing. As illustrated, the camera 500 includes a lens 502 configured to receive light incident upon the lens and to direct received light onto an image sensor internal to the lens for capture by the image sensor. The lens 502 is enclosed by a lens ring 504.

The camera 500 can include various indicators, including the LED lights 506 and the LED display 508 shown in FIG. 5A. When the camera 500 is enclosed within a housing, the LED lights and the LED display 508 are configured to be visible through the housing. The camera 500 can also include buttons 510 configured to allow a user of the camera to interact with the camera, to turn the camera on, to initiate the capture of video or images, and to otherwise configure the operating mode of the camera. The camera 500 can also include one or more microphones 512 configured to receive and record audio signals in conjunction with recording video. The side of the camera 500 includes an I/O interface 514. Though the embodiment of FIG. 5A illustrates the I/O interface 514 enclosed by a protective door, the I/O interface can include any type or number of I/O ports or mechanisms, such as USB ports, HDMI ports, memory card slots, and the like.

FIG. 5B illustrates a rear perspective view of the example camera 500, according to one embodiment. The camera 500 includes a display 518 (such as an LCD or LED display) on the rear surface of the camera 500. The display 518 can be configured for use, for example, as an electronic view finder, to preview captured images or videos, or to perform any other suitable function. The camera 500 also includes an expansion pack interface 520 configured to receive a removable expansion pack, such as an extra battery module, a wireless module, and the like. Removable expansion packs, when coupled to the camera 500, provide additional functionality to the camera via the expansion pack interface 520.

What is claimed is:

1. A camera, comprising:
an image sensor configured to capture light incident upon the image sensor to produce image data, the image data comprising a plurality of pixels; and
a processor configured to:
access image data associated with a pixel, the image data having a first quantity of pass band energy,
generate filtered image data using one or more filters, the filtered image data having a second quantity of pass band energy that is less than the first quantity and having excess side band energy,
transform the filtered image data to generate a set of filtered image coefficients associated with the filtered image data, the set of filtered image coefficients being a representation of the filtered image data in the frequency domain,
adjust the set of filtered image coefficients to compensate for the second quantity of energy being lower than the first quantity of energy based on the excess side band energy to produce an adjusted set of filtered image coefficients,
transform the adjusted set of filtered image coefficients into the spatial domain to produce adjusted image data, and
process the adjusted image data to produce a digital image.

2. The camera of claim 1, wherein the excess side band energy causes crosstalk and overshoot noise in the filtered image data, and wherein adjusting the set of filtered image coefficients comprises determining the second quantity of energy, a third quantity of energy in the crosstalk, and a fourth quantity of energy in the overshoot of the filtered image data.

3. The camera of claim 2, wherein adjusting the set of filtered image coefficients further comprises modifying an amplitude of at least one of the filtered image coefficients based on one or more of the second quantity of energy, the third quantity of energy, and the fourth quantity energy.

4. The camera of claim 2, wherein the set of filtered image coefficients includes a first order filtered image coefficient, and wherein adjusting the set of filtered image coefficients comprises computing an amount by which to adjust the first order filtered image coefficient using the formula:
$${f}_{0 uc} [ \frac{1}{{E}_{IB}} - 1 ] ,$$
where f_{0uc} is the amplitude of the first order filtered image coefficient and E_{IB}is the second quantity of energy.

5. The camera of claim 2, wherein the set of filtered image coefficients includes a second order filtered image coefficient, and wherein adjusting the set of filtered image coefficients comprises computing an amount by which to adjust the second order filtered image coefficient using the formula
$${f}_{\pm 1 uc} [ 1 - \frac{( {E}_{O} + {E}_{C} )}{2} ] ,$$
where f_{+1uc} is the amplitude of the second order filtered image coefficient, E_{C} is the third quantity of energy, and E_{O} is the fourth quantity of energy.

6. The camera of claim 2, wherein the set of filtered image coefficients includes a second order filtered image coefficient, and wherein adjusting the set of filtered image coefficients comprises computing an amount by which to adjust the second order filtered image coefficient using the formula
$${f}_{\pm 1 uc} [ \frac{{E}_{IB}}{2} ] ,$$
where f_{+1uc} is the amplitude of the second order filtered image coefficient and E_{IB} is the second quantity of energy.

7. The camera of claim 2, wherein the set of filtered image coefficients includes a second order filtered image coefficient, and wherein adjusting the set of filtered image coefficients comprises computing an amount by which to adjust the third order filtered image coefficient using the formula
$${f}_{\pm 2 uc} [ \frac{1}{{E}_{IB}} \cdot \frac{1}{2} ] ,$$
where f_{+2uc} is the amplitude of the third order filtered image coefficient and E_{IB} is the second quantity of energy.

8. The camera of claim 2, wherein determining the second, third, and fourth quantities of energy comprises analyzing the filtered image data to measure the pass band energy, the energy in the crosstalk, and the energy in the overshoot.

9. The camera of claim 1, wherein determining the second, third, and fourth quantities of energy comprises identifying a type associated with each of the one or more filters, and computing the second, third, and fourth quantities of energy based on the identified types and the image data.

10. A method for capturing an image with a camera, the method comprising:
capturing, by an image sensor of the camera, light incident upon the image sensor to produce image data, the image data comprising a plurality of pixels;
accessing image data associated with a pixel, the image data having a first quantity of pass band energy;
generating, by a filter engine, filtered image data using one or more filters, the filtered image data having a second quantity of pass band energy that is less than the first quantity and having excess side band energy;
transforming the filtered image data to generate a set of filtered image coefficients associated with the filtered image data, the set of filtered image coefficients being a representation of the filtered image data in the frequency domain;
adjusting the set of filtered image coefficients to compensate for the second quantity of energy being lower than the first quantity of energy based on the excess side band energy to produce an adjusted set of filtered image coefficients;
transforming the adjusted set of filtered image coefficients into the spatial domain to produce adjusted image data; and
processing the adjusted image data to produce a digital image.

11. The method of claim 10, wherein the excess side band energy causes crosstalk and overshoot noise in the filtered image data, and wherein adjusting the set of filtered image coefficients comprises determining the second quantity of energy, a third quantity of energy in the crosstalk, and a fourth quantity of energy in the overshoot of the filtered image data.

12. The method of claim 11, wherein adjusting the set of filtered image coefficients further comprises modifying an amplitude of at least one of the filtered image coefficients based on one or more of the second quantity of energy, the third quantity of energy, and the fourth quantity energy.

13. The method of claim 11, wherein the set of filtered image coefficients includes a first order filtered image coefficient, and wherein adjusting the set of filtered image coefficients comprises computing an amount by which to adjust the first order filtered image coefficient using the formula:
$${f}_{0 uc} [ \frac{1}{{E}_{IB}} - 1 ] ,$$
where f_{0uc} is the amplitude of the first order filtered image coefficient and E_{IB} is the second quantity of energy.

14. The method of claim 11, wherein the set of filtered image coefficients includes a second order filtered image coefficient, and wherein adjusting the set of filtered image coefficients comprises computing an amount by which to adjust the second order filtered image coefficient using the formula
$${f}_{\pm 1 uc} [ 1 - \frac{( {E}_{O} + {E}_{C} )}{2} ] ,$$
where f_{+1uc} is the amplitude of the second order filtered image coefficient, E_{C} is the third quantity of energy, and E_{O} is the fourth quantity of energy.

15. The method of claim 11, wherein the set of filtered image coefficients includes a second order filtered image coefficient, and wherein adjusting the set of filtered image coefficients comprises computing an amount by which to adjust the second order filtered image coefficient using the formula
$${f}_{\pm 1 uc} [ \frac{{E}_{IB}}{2} ] ,$$
where f_{+fuc} is the amplitude of the second order filtered image coefficient and E_{IB} is the second quantity of energy.

16. The method of claim 11, wherein the set of filtered image coefficients includes a second order filtered image coefficient, and wherein adjusting the set of filtered image coefficients comprises computing an amount by which to adjust the third order filtered image coefficient using the formula
$${f}_{\pm 2 uc} [ \frac{1}{{E}_{IB}} \cdot \frac{1}{2} ] ,$$
where f_{+2uc} is the amplitude of the third order filtered image coefficient and E_{IB} is the second quantity of energy.

17. The method of claim 11, wherein determining the second, third, and fourth quantities of energy comprises analyzing the filtered image data to measure the pass band energy, the energy in the crosstalk, and the energy in the overshoot.

18. The method of claim 10, wherein determining the second, third, and fourth quantities of energy comprises identifying a type associated with each of the one or more filters, and computing the second, third, and fourth quantities of energy based on the identified types and the image data.

19. A camera, comprising:
a memory for storing image data associated with a pixel, the image data having a first quantity of pass band energy;
a processor configured to:
generate filtered image data using one or more filters, the filtered image data having a second quantity of pass band energy that is less than the first quantity and having excess side band energy,
transform the filtered image data to generate a set of filtered image coefficients associated with the filtered image data, the set of filtered image coefficients being a representation of the filtered image data in the frequency domain,
adjust the set of filtered image coefficients to compensate for the second quantity of energy being lower than the first quantity of energy based on the excess side band energy to produce an adjusted set of filtered image coefficients, and
transform the adjusted set of filtered image coefficients into the spatial domain to produce adjusted image data.

20. The camera of claim 19, wherein the excess side band energy causes crosstalk and overshoot noise in the filtered image data, and wherein adjusting the set of filtered image coefficients comprises determining the second quantity of energy, a third quantity of energy in the crosstalk, and a fourth quantity of energy in the overshoot of the filtered image data.
